(19) United States
(12) Patent Application Publication
(10) Pub. No.: US 2010/0314144 A1
(43) Pub. Date: Dec. 16, 2010

(54) BLADE ARRANGEMENT FOR DISK HARROWS

(76) Inventor: Mark Hennes, Beloit, KS (US)

Correspondence Address: THOMPSON & THOMPSON, P.A., P.O BOX 166, SCANDIA, KS, 66966, US

(21) Appl. No.: 12/482,399

(22) Filed: Jun. 10, 2009

(51) Int. Cl. A01B 5/00; A01B 23/04; A01B 63/02; A01B 73/04

(52) U.S. Cl. 172/178; 172/776; 172/238; 172/239; 172/311

(57) ABSTRACT

A multisection tandem disk harrow has a frame, a first disk gang, and a second disk gang. The concave sides of the disk blades in the first disk gang face one side of the disk harrow, and the concave sides of the disk blades in the second disk gang face the other side of the disk harrow. The disk blades in the first disk gang are mounted for rotation about a common axis that extends through a center of the disk blades. The disk blades in the second disk gang are mounted for rotation about respective individual axes that are substantially parallel with and spaced apart from each other. The first and second disk gangs are arranged so that the common axis of the first disk gang is nonparallel with the individual axes of the second disk gang. Various frame, support wheels, disk gang, and hitch configurations are also disclosed.

### BACKGROUND OF THE INVENTION

1. Field of the Invention

The present invention relates generally to tillage equipment, and in particular, to disk harrow implements having a front disk gang followed by a rear disk gang.

2. Description of the Related Art

Disk harrows are implements used to cultivate the surface of the soil. Disk harrows can be used to break up clods and lumps of soil, size and bury crop residue, and to provide a finer finish, a good tilth or soil structure that is suitable for seeding and planting operations. Disk harrows can also be used to remove weeds and to help level the surface of a rough field.

Conventional disk harrows include gangs of disk blades supported for rotation by bearings mounted on hangers that extend downwardly from a frame. The disk gangs usually have a plurality of concave disks mounted for rotation on a common axis that extends at an angle to the direction of travel of the implement. Various arrangements of disk gangs are known in the prior art.

An early disk harrow is disclosed in U.S. Pat. No. 2,588,709 to Elliott. This disk harrow had a single section frame that supported a front gang of individually mounted disk blades and a rear gang of disk blades mounted for rotation on a common axis. This disk harrow design did not use a tandem disk gang arrangement in which the right and left sides of the implement were mirror images of each other, and therefore, required turning in the same direction and working a field round and round like a plow. Moreover, Elliott's disk harrow was a single section implement that was not designed to fold between a relatively wide position for fieldwork and a relatively narrow position for transport. Elliott did not contemplate that a gang of individually mounted disk blades could provide substantial advantages in a wide tandem disk harrow having multiple sections.

Tandem disks harrows are commonly used today because they allow more flexibility in how a field is worked and because they can be made in multiple sections that can be folded for transport. Tandem disk harrows have right and left sides that are mirror images of each other, and typically have disk gangs with a plurality of disk blades mounted for rotation on a common axis. The disk gangs are arranged so that the disk blades of the leading disk gang are at an angle to move soil in an opposite direction relative to the soil moved by the disk blades of the trailing disk gang. For example, a diamond-shaped disk gang arrangement is disclosed in U.S. Pat. No. 5,881,820 to Baker, and an outwardly diverging disk gang arrangement is disclosed in U.S. Pat. No. 4,044,842 to Worick. In these conventional tandem disk gang arrangements, the disk gangs diverge from each other in either an outward or inward direction so that a distance between the gangs becomes quite large for a wide disk harrow implement.

The conventional arrangement of diverging disk gangs has limited the design of larger size disk harrows, which are growing in demand for use with today's larger size tractors. The conventional arrangement of disk gangs also creates challenges in maintaining transport dimensions that are as narrow and short as possible to improve public safety on public roadways. Large size disk harrows also result in an increased overall weight of the implement that must be transported from field-to-field on transport tires. The transport tires for these implements are sometimes undersized and overloaded, causing additional public safety concerns.

There is a need in the industry for an improved disk harrow design that overcomes the problems with the conventional disk harrows described above.

### SUMMARY OF THE INVENTION

An object of the present invention is to provide a disk harrow design that prevents or minimizes the divergence of disk gangs on the outer ends of the disk harrow to allow larger width disk harrows.

A further object of the present invention is to provide a multisection disk harrow design that maintains transport dimensions that are as narrow and short as possible, and that allows more tires on the road during transport, to improve transport safety, reduce down time, and increase productivity.

A further object of the present invention is to provide a disk harrow having better leveling and weed kill performance for increased field output productivity and lower fuel consumption requirements.

A further object of the present invention is to provide a disk harrow having the ability to perform leveler, faster and at shallower working depths for optimal seedbed preparation and moisture conservation.

A further object of the present invention is to provide a disk harrow that simplifies the operational duties required by the operator to achieve the desired result, while preventing unwanted field ridges, excessive fuel consumption and lost soil moisture.

To achieve these and other objects of the present invention, an improved disk harrow has been developed by the Applicant having a frame supported by a plurality of depth gauging wheels, and first and second disk gangs connected to the frame. The first and second disk gangs are spaced apart from each other along a direction of travel so that one is positioned behind the other, with the first disk gang being either the front or rear disk gang, and the second disk gang being the other of the front or rear disk gang. The first and second disk gangs each comprises a group of substantially circular disk blades mounted to the frame for rotational movement. The disk blades each have a concave side and a convex side, and each gang is arranged so that the concave sides of the disk blades face at least slightly forward relative to a direction of travel. The concave sides of the first disk gang face one side of the disk harrow, and the concave sides of the second disk gang face the other side of the disk harrow.

One group of disk blades are mounted for rotational movement about a common axis of rotation that extends through a center of the disk blades. Another group of disk blades are mounted for rotation about respective individual axes of rotation that are substantially parallel with and spaced apart from each other. In some of the disclosed embodiments, the first and second disk gangs are substantially parallel with each other, which minimizes the distance required between the disk gangs. In other embodiments, the first and second disk gangs are nonparallel, but are arranged so that they do not diverge apart from each other as far as the diverging gangs of conventional tandem disks. In all of the disclosed embodiments, the common axis of the disk blades in the first disk gang are nonparallel with the individual axes of the disk blades in the second disk gang. This arrangement of the first and second disk gangs allows the disk gangs to be mounted closer together, thereby reducing the size of the frame and providing other advantages over conventional disk harrows.

Various configurations for the frame, support wheels, and disk gangs are also disclosed in this application.

Numerous other objects of the present invention will be apparent to those skilled in this art from the following description wherein there is shown and described exemplary embodiments of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective view of a five-section disk harrow according to the present invention.

FIG. 2 is a plan view illustrating the arrangement of disk blades and depth gauging wheels of the disk harrow of the present invention.

FIG. 3 is an elevation view showing a floating hitch and draft line of the disk harrow of the present invention.

FIG. 4 is another elevation view showing the floating hitch as the disk harrow traverses a high area of a field.

FIG. 5 is another elevation view showing the floating hitch as the disk harrow traverses a low area of a field.

FIG. 6 is a perspective view showing the five-section disk harrow in a folded transport configuration.

FIG. 7 is a rear view showing the five-section disk harrow in its folded transport configuration.

FIG. 8 is a plan view illustrating a blade and tire arrangement according to an alternative embodiment of the present invention.

FIG. 9 is a plan view illustrating a blade and tire arrangement according to another alternative embodiment of the present invention.

FIG. 9A is a plan view illustrating a blade and tire arrangement according to another alternative embodiment of the present invention.

FIG. 10 is a plan view illustrating a blade and tire arrangement according to another alternative embodiment of the present invention.

FIG. 11 is a plan view illustrating a blade and tire arrangement according to another alternative embodiment of the present invention in which the front and rear disk gangs are nonparallel.

FIG. 12 is a plan view illustrating a disk harrow having a rear folding configuration for transport.

FIG. 13 is a perspective view of an individually mounted disk blade according to one embodiment of the present invention.

FIG. 14 is a perspective view of an individually mounted disk blade according to another embodiment of the present invention.

FIG. 15 is a perspective view of an individually mounted disk blade according to another embodiment of the present invention.

FIG. 16 is a perspective view of an individually mounted disk blade according to another embodiment of the present invention.

### DETAILED DESCRIPTION OF THE INVENTION

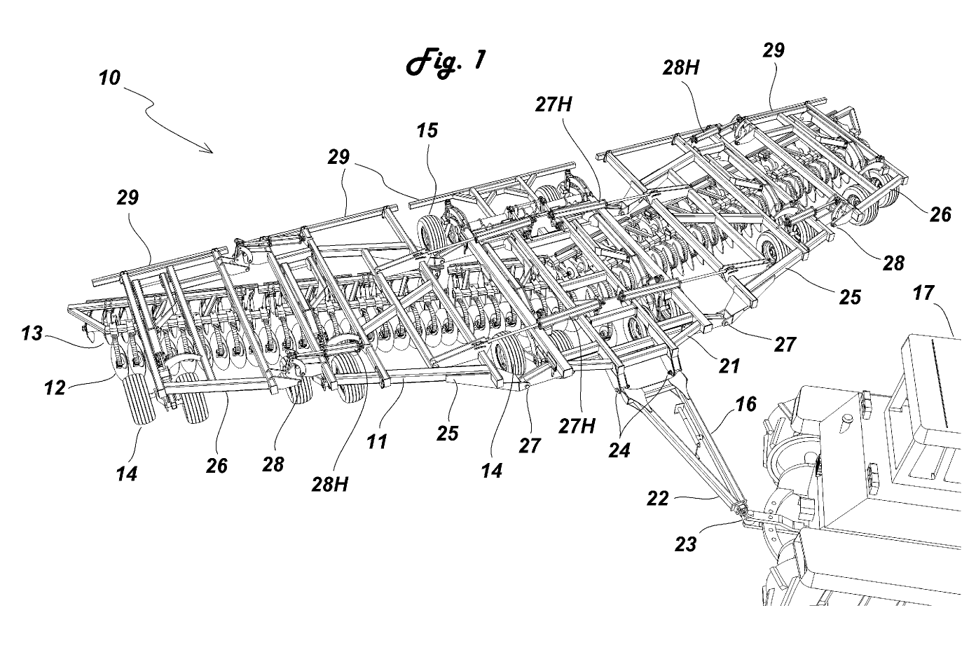

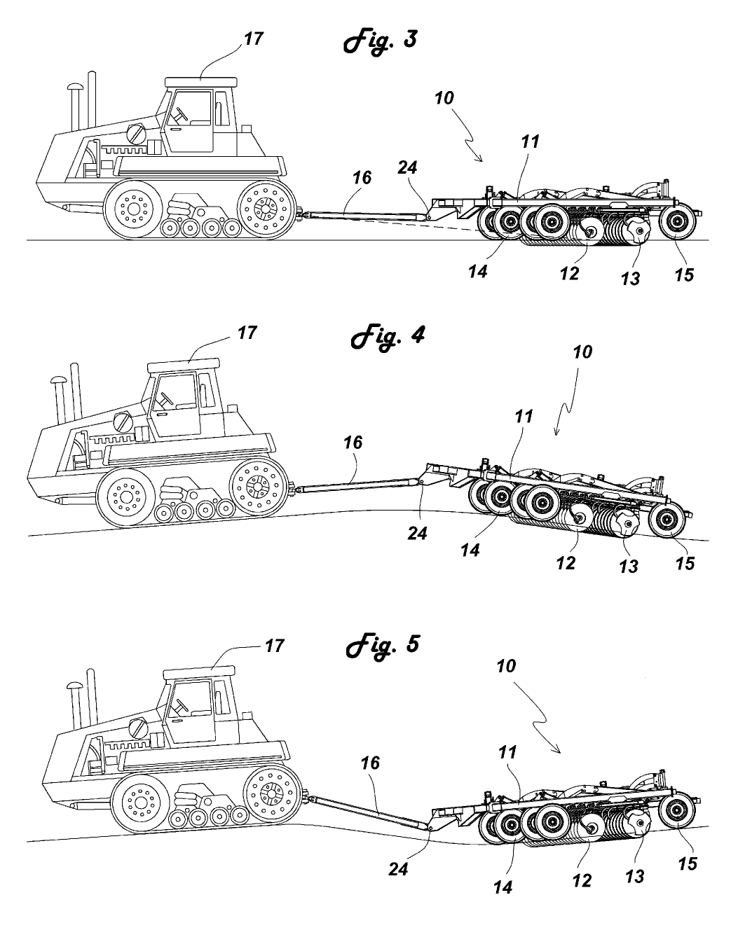

A tandem disk harrow according to embodiments of the present invention will now be described in detail with reference to FIGS. 1 to 16 of the accompanying drawings.

A five-section tandem disk harrow 10 according to the present invention is shown in FIG. 1. The disk harrow 10 has a frame 11, a front disk gang 12, a rear disk gang 13, a plurality of depth gauging wheels 14, 15, and a substantially free floating hitch assembly 16. The disk harrow 10 can be attached to a tractor 17 and used to provide either primary or secondary tillage of an agricultural field.

A portion of the disk harrow 10 is shown in plan view in FIG. 2. The frame 11 and outer wing sections of the disk harrow 10 have been omitted from FIG. 2 to provide a clearer illustration of the arrangement of the disk gangs 12, 13 and the depth gauging wheels 14, 15.

In FIG. 2, the front and rear disk gangs 12, 13 on each side of the longitudinal centerline C of the disk harrow 10 are substantially parallel and spaced apart from each other along a direction of travel. The front and rear disk gangs 12, 13 each form a V-shaped configuration in plan view. The apex of each of the V-shaped configurations is located near the longitudinal centerline C of the disk harrow 10. The disk gangs 12, 13 each extend outwardly and rearwardly from the apex of the respective V-shaped configurations. Additional individually mounted disk blades 18, 19 are positioned near the longitudinal centerline C to help avoid skips in the field at the center of the disk harrow 10.

The front disk gang 12 has a left side 12L and a right side 12R, with the right side 12R having a structure that substantially mirrors the left side 12L. The rear disk gang 13 also has a left side 13L and a right side 13R, with the right side 13R having a structure that substantially mirrors the left side 13L. The left and right sides of the front disk gang 12 are arranged such that together they form a first V-shape in plan view. The left and right sides of the rear disk gang 13 are arranged such that together they form a second V-shape in plan view. The apex of each of the V-shapes points toward a leading end of the disk harrow 10 in the FIG. 2 embodiment.

Each of the disk gangs 12, 13 comprises a plurality of substantially circular disk blades 12D, 13D mounted to the frame 11 for rotational movement. For purposes of this application, a “disk gang” refers to a group of at least three disk blades 12D, 13D arranged side-by-side in spaced relationship relative to each other and facing in substantially the same direction. The disk blades 12D, 13D each have a concave side and a convex side. The disk blades 12D, 13D of both the front and rear disk gangs 12, 13 are arranged so that the concave sides of the disk blades face at least slightly forward relative to a direction of travel. This arrangement allows the disk blades 12D, 13D to cut into and turn soil as the disk harrow 10 traverses a field.

The front disk gang 12 has a first group of disk blades 12D on one side of the centerline C (e.g., the left side), and the rear disk gang 13 has a second group of disk blades 13D that follow behind the first group. The disk blades 12D of the first group are arranged with their concave sides facing substantially toward one side of the disk harrow (e.g., the left side), and the disk blades 13D of the second group are arranged with their concave sides facing substantially toward the other side of the disk harrow (e.g., the right side). The front and rear disk gangs 12, 13 on the other side of the centerline C of the disk harrow 10 are similarly arranged and substantially mirror the first and second groups of disk blades 12D, 13D, respectively.

The first group of disk blades 12D are mounted for rotational movement about respective individual axes of rotation 12A. The individual axes of rotation 12A are generally horizontal, and are also substantially parallel with and spaced apart from each other. Each of the disk blades 12D is individually mounted to the frame 11 for rotation about its own bearing 20. In the embodiment shown in FIG. 2, the individual axes of rotation 12A for the first group of disk blades 12D (on the front left side) are arranged so that the axes 12A extend leftward and slightly forward from the centerline C of the disk harrow 10.

The second group of disk blades 13D are mounted for rotational movement about a common axis of rotation 13A. The common axis of rotation 13A for the second group of disk blades 13D is generally horizontal, and is also nonparallel with the individual axes 12A of the first group of disk blades 12D. In the embodiment shown in FIG. 2, the common axis of rotation 13A for the second group of disk blades 13D (on the rear left side) of the disk harrow 10 is arranged to extend leftward and slightly rearward from the centerline C of the disk harrow 10.

The depth gauging wheels comprise at least a first set of wheels 14 arranged in front of the front disk gang 12, and at least a second set of wheels 15 arranged behind the rear disk gang 13. The depth gauging wheels 14, 15 function to maintain a desired depth of the disk gangs 12, 13 relative to a field surface with the disk harrow 10 in its unfolded configuration, and to support the center section 21 of the frame 11 for transport with the disk harrow 10 in its folded configuration.

In the FIG. 2 embodiment, the first set of wheels 14 includes four pairs of wheels supporting the frame 11 in front of the front disk gang 12, and the second set of wheels 15 includes two pairs of wheels supporting the center section 21 of the frame 11 behind the rear disk gang 13. By having the front and rear disk gangs 12, 13 parallel to each other, the frame 11 can be kept much more compact, and it is unnecessary to have additional depth gauging wheels between the front and rear disk gangs 12, 13.

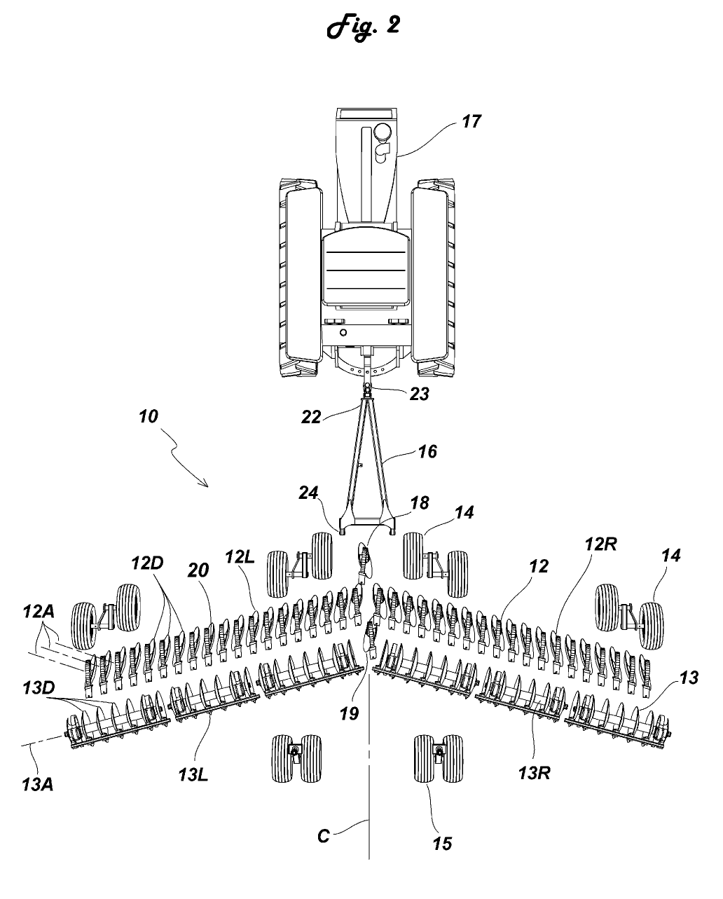

The hitch assembly 16 comprises a tongue 22 having a hitch coupler 23 at its leading end for connecting the disk harrow 10 to a vehicle, such as an agricultural tractor 17. The hitch assembly 16 is pivotally connected at its rearward end to a leading end of the frame 11 by respective right and left pivot pins 24. As illustrated in FIGS. 3 to 5, the pivot pins 24 allow the hitch assembly 16 to have substantially free floating hitch movement relative to the frame 11 as the disk harrow 10 traverses uneven terrain. The close proximity of the depth gauging wheels 14 to the front of the front disk gang 12 makes it possible to have uniform operating depth across the entire width of the disk harrow 10 without the need for additional support wheels behind the rear disk gang or a self-leveling/spring cushion assembly typically used on conventional disk harrows.

The frame 11 of the disk harrow has multiple sections that allow the frame 11 to be folded between a first configuration with a relatively narrow width for transport (FIGS. 6 and 7), and a second configuration with a relatively wide width for field operation (FIG. 1). In the embodiment shown in FIGS. 1, 6 and 7, the multiple sections of the frame 11 include five sections: the center section 21, a pair of inner wing sections 25 pivotally mounted to respective outer sides of the center section 21, and a pair of outer wing sections 26 pivotally mounted to respective outer sides of the inner wing sections 25. The multiple sections 21, 25, 26 of the frame 11 are arranged to flex relative to each other as the disk harrow 10 traverses uneven terrain when the frame 11 is in its unfolded configuration.

The multiple sections 21, 25, 26 are pivotally attached to each other by pivot connections 27, 28. The pivot connections 27, 28 have pivot axes that extend in a generally horizontal plane parallel with the longitudinal centerline C of the disk harrow 10. A first set of hydraulic actuators 27H are connected between the center frame section 21 and the inner wing sections 25 to move the inner wing sections 25 between their folded and unfolded configurations relative to the center section 21. A second set of hydraulic actuators 28H are connected between the inner wing sections 25 and the outer wing sections 26 to move the outer wing sections 26 between their folded and unfolded configurations relative to the inner wing sections 25.

The pivot connections 27 between the center section 21 and the inner wing sections 25 are located at relatively low points on the frame sections 21, 25. This allows the inner wing sections 25 to flex relative to the center section 21 without creating a large gap between the disk blades 12D, 13D adjacent to the pivot connections 27. By keeping the pivot connections 27, and hence the pivot axes, closer to the cutting surfaces of the disks 12D, 13D, the flex movement of the inner wing sections 25 relative to the center section 21 creates only a small change in the gap between the disk blades 12D, 13D adjacent to the pivot axes.

Similarly, the pivot connections 28 between the inner wing sections 25 and the outer wing sections 26 are also located at relatively low points on the frame sections 25, 26 to minimize the change in spacing between the disk blades 12D, 13D adjacent to the pivot connections 28 as the sections 25, 26 flex relative to each other. The pivot connections 28 between the wing sections 25, 26 also have a structure that allows the outer wing sections 26 to pivot a full 180 degrees to fold onto the inner wing sections 25 when the disk harrow 10 is moved from its unfolded configuration for field work to its folded configuration for transport.

A tool bar 29 is provided across the back end of each of the frame sections 21, 25, 26 of the frame 11. A conventional finishing attachment, such as a coil tine or spike tooth harrow (not shown), can be attached to the tool bar 29 in a known manner to redistribute residue and smooth the field surface behind the disk gangs 12, 13.

Other disk harrow embodiments that incorporate at least some of the features of the present invention are also contemplated. For example, FIG. 8 shows a disk harrow 40 in which a V-shape created by the disk gangs 41, 42 has an apex that points toward a trailing end of the disk harrow 40. Also, the left and right portions of the disk gangs 41, 42 in this embodiment do not come precisely together at the apex of the V-shape, and instead are slightly offset along a direction of travel. This allows the left and right portions of the disk gangs 41, 42 to overlap slightly to avoid skipped areas in the field. This embodiment also illustrates that the concave sides of the disk blades can be reversed, as compared with the embodiment shown in FIG. 2, so that the concave sides of the disk blades in the front disk gang 41 face toward the longitudinal centerline C, and the concave sides of the disk blades in the rear disk gang 42 face outwardly from the centerline C.

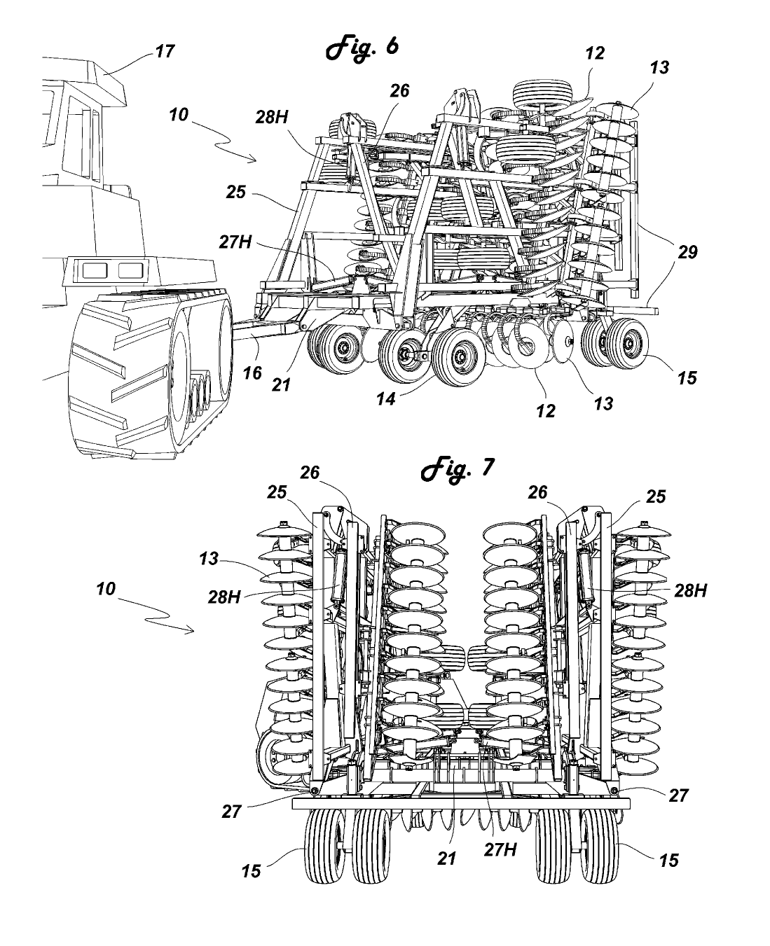

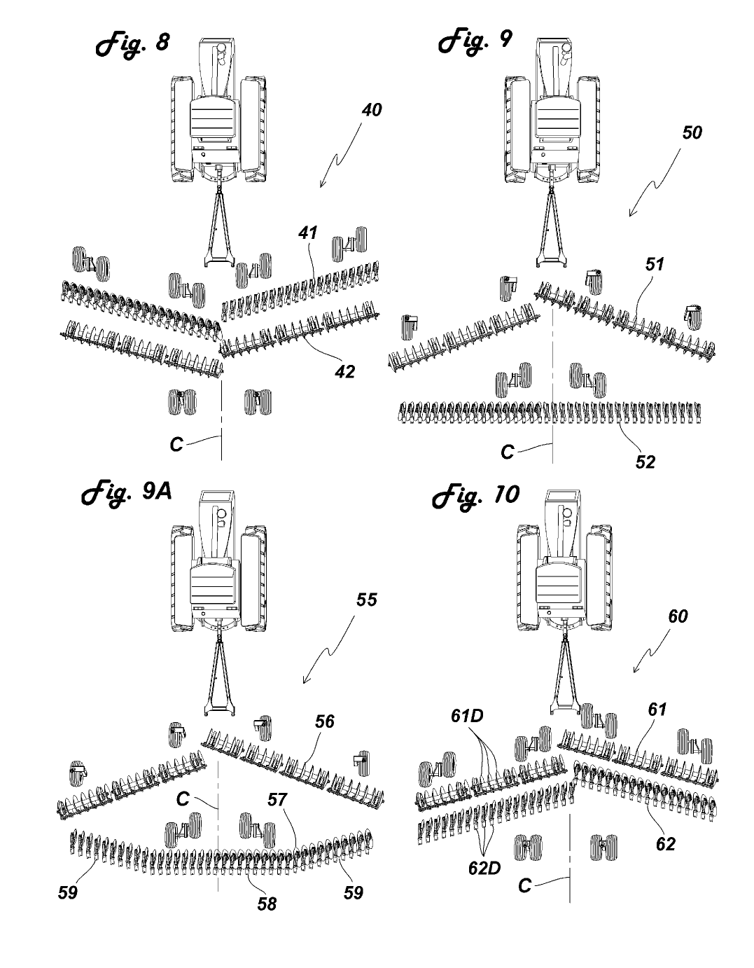

FIG. 9 shows a disk harrow 50 having a front disk gang 51 that forms a V-shape with the apex at a leading end, and a rear disk gang 52 arranged in a line generally perpendicular to the direction of travel. Thus, the front and rear disk gangs 51, 52 are nonparallel with each other in this embodiment. The right and left sides of the front disk gang 51 each comprises a group of disk blades mounted for rotational movement about a common axis of rotation, while the rear disk gang 52 comprises disk blades that are mounted for rotation about respective individual axes of rotation.

In this embodiment, the front and rear disk gangs 51, 52 are spaced apart from each other along a direction of travel so that the rear disk gang 52 follows behind the front disk gang 51. However, it should be understood that an alternative embodiment of the disk harrow could be made in which the disk gang 51 follows behind the disk gang 52. The disk gangs 51, 52 would still be spaced apart from each other along a direction of travel in this alternative design, with the disk gang 51 following behind the disk gang 52.

FIG. 9A shows a disk harrow 55 in plan view according to another embodiment. The disk harrow 55 has a front disk gang 56 that forms a V-shape with the apex at a leading end, and a rear disk gang 57 comprising a plurality of disk blades that are mounted for rotation about respective individual axes of rotation. In this embodiment, the rear disk gang 57 has a center section 58 arranged in a line generally perpendicular to the direction of travel, and outer sections 59 arranged at an angle relative to the center section. The rear disk gang 57 is therefore flat across its center section 58, with its outer sections 59 angled slightly toward the front disk gang 56. The flat center section 58 of the rear disk gang 57 helps shorten the center frame and simplify the toolbar at the rear of the harrow for mounting a coil tine attachment.

FIG. 10 shows a disk harrow 60 in which the front disk gang 61 is similar to the rear disk gang 13 shown in the FIG. 2 embodiment, and the rear disk gang 62 is similar to the front disk gang 12 shown in the FIG. 2 embodiment. Specifically, the front disk gang 61 comprises a group of disk blades 61D mounted for rotational movement about a common axis of rotation, and the rear disk gang 62 comprises a group of disk blades 62D mounted for rotational movement about respective individual axes of rotation.

FIG. 11 shows a disk harrow 70 in which the front disk gang 71 is nonparallel with the rear disk gang 72. The front disk gang 71 comprises a group of disk blades mounted for rotational movement about respective individual axes of rotation. The rear disk gang 72 comprises a group of disk blades mounted for rotational movement about a common axis of rotation. In this embodiment, the front and rear disk gangs 71, 72 diverge from each other in a direction away from the centerline. However, due to the individually mounted disk blades in the front disk gang 71, the divergence of the gangs need not be as great as in a conventional disk harrow to achieve an optimal cutting angle for the disk blades in both the front and rear gangs.

FIG. 12 shows a disk harrow 80 having a frame arrangement in which the multiple sections of the frame 81 are foldable to a transport configuration by movement within a generally horizontal plane. Specifically, the frame 81 has respective pivot connections 82 on each side of a center section 83 that allow the wing sections 84 to pivot rearwardly and be supported on a trailing set of support wheels 85. Hydraulic cylinders 86 are provided to move the frame 81 between its folded and unfolded configurations.

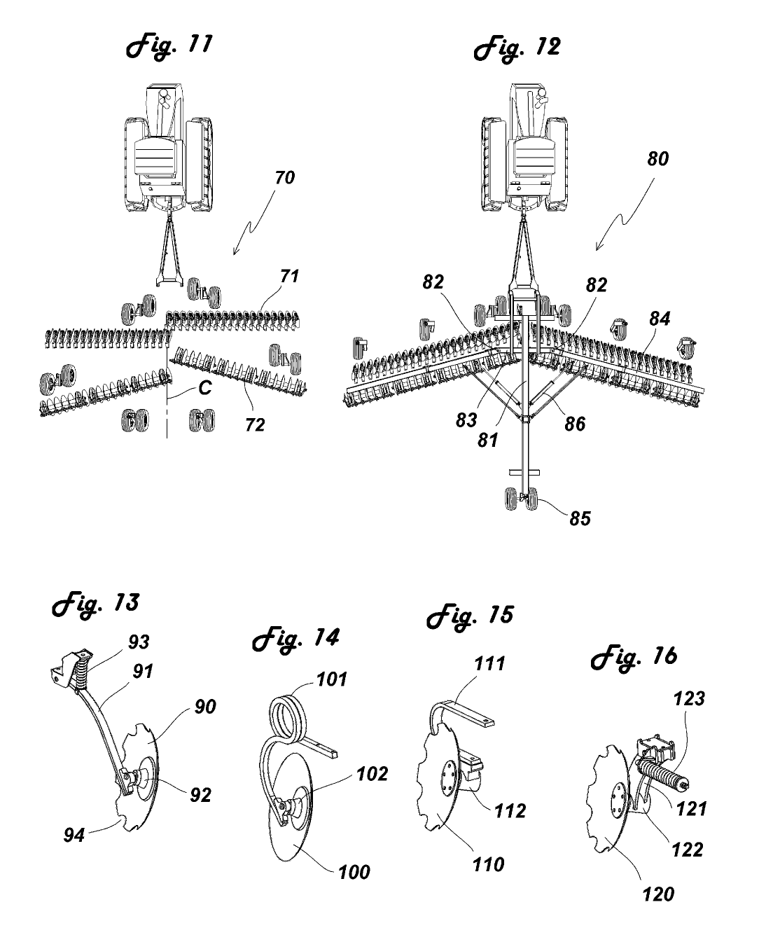

FIGS. 13 to 16 illustrate various embodiments for mounting individual disk blades for rotational movement about an individual axis of rotation. In FIG. 12, the disk blade 90 is mounted to a support arm 91 by a bearing assembly 92 located on the concave side of the disk blade 90. A spring 93 is arranged to apply a downwardly directed spring bias on the disk blade 90. The disk blade 90 is substantially circular with cutouts 94 in its outer periphery to improve operation in high residue conditions.

In FIG. 14, the disk blade 100 is mounted to a resilient spring arm 101 by a bearing assembly 102 located on the concave side of the disk blade 100.

In FIG. 15, the disk blade 110 is mounted to a curved leaf spring 111 by a bearing assembly 112 located on the convex side of the disk blade 110.

In FIG. 16, the disk blade 120 is mounted to a rigid arm 121 by a bearing assembly 122 located on the convex side of the disk blade 120. The rigid arm 121 is connected to a spring-loaded tripping assembly 123 that allows the arm 121 to move relative to the frame 11 when it encounters an obstruction in the field.

The disk harrow embodiments described above provide several significant advantages over conventional disk harrows. For example, the disk harrow 10 has improved leveling performance in both even and uneven field conditions. The combination of the substantially free floating hitch assembly 16, depth gauging wheels 14 in front of the front disk gangs 12 across all of the sections 21, 25, 26 of the disk harrow 10, close proximity of the front disk gang 12 to the rear disk gang 13, and flexibility between multiple sections of the frame 11 give the disk harrow 10 improved ground hugging performance.

The disk harrow 10 also has the ability to disk at shallower depths without weed skips while allowing higher operating speeds, improves fuel economy, and increases field production.

The disk harrow 10 also provides simpler operation coupled with reduced frame and hitch fatigue failures. The substantially free floating hitch assembly 16 eliminates the need for front to rear leveling adjustments and thereby avoids the stress on the frame and hitch members that are induced by conventional leveling systems.

The multiple section design of the present invention can be used to provide a disk harrow 10 having five or more sections with true field flexing between each of the sections. The close proximity of the front disk gang 12 to the rear disk gang 13 allows a much more compact frame 11 to be used, even for extremely wide disk harrow widths.

The disk harrow 10 also has an arrangement of wheels 14, 15 that results in more tires on the road for safer transport of large, heavy implements. For example, the disk harrow 10 illustrated in FIGS. 1 and 2 has eight transport tires on the road, while conventional disk harrows typically have only four or fewer tires on the road. The present invention thus provides a safer transport experience resulting in greater productivity and less down time.

The V-shape formed by the left and right portions of the disk gangs 12, 13, together with the apex of the V-shape being positioned at the leading end of the disk harrow 10, gives the disk harrow 10 the ability to turn in any direction while the machine is in operation without causing ridges.

The present invention provides a multisection tandem disk harrow that prevents or minimizes the divergence of the gangs on the outer ends of the disk harrow. This disk harrow design allows larger size disk harrows to be built to accommodate the ever growing larger size of new tractors, while at the same time maintaining transport dimensions that are as narrow and short as possible to improve public safety.

Along with a more compact front to rear blade arrangement and a safer, smaller set of transport dimensions, the present invention also provides better leveling and weed kill performance for increased field output productivity and lower fuel consumption requirements. The disk harrow can also be used efficiently in a secondary tillage operation prior to spring or fall seeding because it has the ability to perform leveler, faster and at shallower working depths, which is critical for optimal seedbed preparation and moisture conservation. The present invention also provides sufficient tire flotation and front gang depth gauging, which result in a disk harrow that works well in both heavy primary and light secondary operations.

While the invention has been specifically described in connection with specific embodiments thereof, it is to be understood that this is by way of illustration and not of limitation, and the scope of the appended claims should be construed as broadly as the prior art will permit.

1. A disk harrow, comprising:
a frame;
a first disk gang connected to said frame, said first disk gang comprising left and right portions that substantially mirror each other on respective sides of a centerline of the disk harrow, each of said left and right portions of the first disk gang comprising a first group of substantially circular disk blades each of which have a concave side and a convex side and each of which are individually mounted to said frame for rotation about its own bearing for rotational movement about respective individual axes of rotation with the concave side facing at least slightly forwardly relative to a direction of travel, said individual axes of rotation on said left portion being substantially parallel with and spaced apart from each other, and said individual axes of rotation on said right portion being substantially parallel with and spaced apart from each other; and
a second disk gang connected to said frame, said second disk gang being spaced apart from the first disk gang along a direction of travel, said second disk gang comprising left and right portions that substantially minor each other on respective sides of said centerline of the disk harrow, each of said left and right portions of the second disk gang comprising a second group of substantially circular disk blades each of which have a concave side and a convex side and each of which are mounted for rotational movement about a common axis of rotation on the left and right portions of the second disk gang, respectively, with the concave side facing at least slightly forwardly relative to a direction of travel, said common axis on the left portion of said second disk gang being nonparallel with said individual axes of rotation of the disk blades on the left portion of said first disk gang, and said common axis on the right portion of said second disk gang being nonparallel with said individual axes of rotation of the disk blades on the right portion of said first disk gang.

2. The disk harrow according to claim 1, wherein the disk blades of said left portion of said first disk gang are arranged with their concave sides facing substantially toward a first lateral side of the disk harrow, and wherein the disk blades of said left portion of said second disk gang are arranged with their concave sides facing substantially toward a second lateral side of the disk harrow which is opposite to said first lateral side.

3. The disk harrow according to claim 1, wherein said left and right portions of second disk gang are substantially parallel with said left and right portions of said first disk gang, respectively.

4. The disk harrow according to claim 1, wherein said left and right portions of said second disk gang are arranged such that together they form a first V-shape in plan view.

5. The disk harrow according to claim 4, wherein said left and right portions of said first disk gang are generally perpendicular to the direction of travel when said disk harrow is configured for field work.

6. The disk harrow according to claim 4, wherein said first disk gang comprises a center section having left and right portions that are each arranged along a line that extends generally perpendicular to the direction of travel when configured for field work, and said first disk gang further comprises left and right outer sections arranged along respective lines that are angled at least slightly toward said second disk gang when configured for field work.

7. The disk harrow according to claim 4, wherein said left and right portions of said first disk gang are arranged such that together they form a second V-shape in plan view.

8. The disk harrow according to claim 7, wherein said first and second V-shapes each has an apex that points toward a leading end of the disk harrow.

9. The disk harrow according to claim 7, wherein said first and second V-shapes each has an apex that points toward a trailing end of the disk harrow.

10. The disk harrow according to claim 1, further comprising a first plurality of depth gauging wheels arranged in front of said first and second disk gangs, and a second plurality of depth gauging wheels arranged behind said first and second disk gangs, whereby said first and second pluralities of depth gauging wheels maintain a desired depth of said disk gangs relative to a field surface during operation.

11. The disk harrow according to claim 1, further comprising:
a first plurality of depth gauging wheels arranged in front of said first and second disk gangs, and a second plurality of depth gauging wheels arranged behind at least one of said first and second disk gangs, whereby said first and second pluralities of depth gauging wheels maintain a desired depth of said disk gangs relative to a field surface during operation; and
a substantially free floating hitch assembly connected to said frame that allows substantially free floating hitch movement relative to said frame as the disk harrow traverses uneven terrain.

12. The disk harrow according to claim 1, wherein said frame has multiple sections that allow the frame to be folded between a first configuration with a relatively narrow width for transport and a second configuration with a relatively wide width for field operation.

13. The disk harrow according to claim 12, wherein said multiple sections of said frame are arranged to flex relative to each other as the disk harrow traverses uneven terrain when the frame is in said second configuration.

14. The disk harrow according to claim 12, wherein said multiple sections of said frame comprise a center section, a pair of inner wing sections pivotally mounted to respective outer sides of said center section, and a pair of outer wing sections pivotally mounted to respective outer sides of said inner wing sections.

15. The disk harrow according to claim 14, wherein said inner wing sections are arranged to flex relative to said center section and said outer wing sections are arranged to flex relative to said inner wing sections as the disk harrow traverses uneven terrain with the frame in said second configuration.

16. The disk harrow according to claim 12, wherein said multiple sections are pivotally attached to each other by pivot axes that extend in a generally horizontal plane.

17. The disk harrow according to claim 12, wherein said multiple sections of said frame are foldable between said first and second configurations by movement of said multiple sections within a generally horizontal plane.

18. A disk harrow, comprising:
a frame;
a first disk gang connected to said frame, said first disk gang comprising a first group of substantially circular disk blades mounted to said frame for rotational movement, each of said first group of disk blades having a concave side and a convex side with the concave side facing at least slightly forwardly relative to a direction of travel, each of said first group of disk blades being individually mounted to said frame for rotational movement about respective individual axes of rotation;
a second disk gang connected to said frame, said second disk gang being spaced apart from the first disk gang along a direction of travel, said second disk gang comprising a second group of substantially circular disk blades each of which have a concave side and a convex side and each of which are mounted for rotational movement with the concave side facing at least slightly forwardly relative to a direction of travel;
said first disk gang comprises left and right portions that mirror each other on respective sides of a centerline of the disk harrow, and wherein said second disk gang comprises left and right portions that minor each other on respective sides of the centerline, wherein the left portion of said first disk gang is substantially parallel with the left portion of said second disk gang, and the right portion of said first disk gang is substantially parallel with the right portion of said second disk gang, and
said individual axes of rotation for the disk blades on the left portion of the first disk gang are substantially parallel with and spaced apart from each other, said individual axes of rotation for the disk blades on the right portion of the first disk gang are substantially parallel with and spaced apart from each other, a first common axis of rotation for the disk blades on the left portion of the second disk gang is nonparallel with the individual axes of rotation of the disk blades on the left portion of the first disk gang, and a second common axis of rotation for the disk blades on the right portion of the second disk gang is nonparallel with the individual axes of rotation of the disk blades on the right portion of the first disk gang.

19. The disk harrow according to claim 18, wherein said left and right portions of said first disk gang are arranged such that together they form a V-shape in plan view.

20. The disk harrow according to claim 18, further comprising a first plurality of depth gauging wheels arranged in front of said disk gangs, and a second plurality of depth gauging wheels arranged behind said disk gangs, whereby said first and second pluralities of depth gauging wheels maintain a desired depth of said disk gangs relative to a field surface during operation.

21. The disk harrow according to claim 18, further comprising:
a first plurality of depth gauging wheels arranged in front of said first and second disk gangs, and a second plurality of depth gauging wheels arranged behind at least one of said first and second disk gangs, whereby said first and second pluralities of depth gauging wheels maintain a desired depth of said disk gangs relative to a field surface during operation; and
a substantially free floating hitch assembly connected to said frame that allows substantially free floating hitch movement relative to said frame as the disk harrow traverses uneven terrain.

22. The disk harrow according to claim 18, wherein said frame has multiple sections that allow the frame to be folded between a first configuration with a relatively narrow width for transport and a second configuration with a relatively wide width for field operation.

23. The disk harrow according to claim 22, wherein said multiple sections are pivotally attached to each other by pivot axes that extend in a generally horizontal plane.

24. The disk harrow according to claim 22, wherein said multiple sections of said frame are foldable between said first and second configurations by movement of said multiple sections within a generally horizontal plane.

25. The disk harrow according to claim 6, further comprising a first plurality of depth gauging wheels arranged on said center section in front of said first and second disk gangs, and a second plurality of depth gauging wheels arranged behind at least one of said first and second disk gangs on said center section, whereby said first and second pluralities of depth gauging wheels maintain a desired depth of said disk gangs relative to a field surface during operation.
